(19) United States
(12) Patent Application Publication
(10) Pub. No.: US 2026/0317236 A1
(43) Pub. Date: Oct. 15, 2026

(54) AMINO COMPOUND-CONTAINING DISPERSION POWDER COMPOSITIONS

(71) Applicant: WACKER CHEMIE AG, Munich (DE)

(72) Inventors: Markus BANNWARTH, Burghausen (DE); Benjamin Rossbach, Burghausen (DE)

(73) Assignee: WACKER CHEMIE AG, Munich (DE)

(21) Appl. No.: 19/108,463

(22) PCT Filed: Sep. 6, 2022
(86) PCT No.: PCT/EP2022/074769

§ 371 Date: Mar. 4, 2025

(51) Int. Cl. C04B 28/02; C04B 40/00; C04B 103/00; C04B 111/00; C04B 111/10

(52) U.S. Cl. CPC C04B 28/02; C04B 40/0042; C04B 2103/0057; C04B 2111/00482; C04B 2111/00637; C04B 2111/10

(57) ABSTRACT

A water-redispersible dispersible powder composition is based on copolymers of a) vinyl acetate, b) ethylene, c) optionally one or more auxiliary monomers, and d) optionally one or more further ethylenically unsaturated monomers. Present in the water-redispersible dispersible powder composition are one or more amino compounds selected from the group comprising polyoxyalkylene amines, polyethyleneimines, aliphatic polyamines, and compounds of formula R—NR′H. The water-redispersible dispersible powder composition is based to an extent of 40% to 99% by weight of the copolymers, based on the total weight of the water-redispersible dispersible powder composition, and the water-redispersible dispersible powder composition does not contain any compounds bearing epoxy groups.

The invention relates to water-redispersible dispersible powder compositions comprising amino compounds, to processes for the production thereof, and to the use thereof in coating compositions or adhesives in particular, for example for the construction sector.

Water-redispersible polymer powders (dispersible powders) are generally obtained by drying aqueous polymer dispersions. The drying is often carried out in the presence of drying aids, which allows a shell of drying aid to form around the polymer particles. In the drying process, drying aids can prevent the polymer particles from sticking together irreversibly during production, storage, transport, and use in dry formulations. On dispersion of dispersible powders in water, the drying aid matrix redissolves, resulting in the polymer particles being released again in the aqueous dispersion and being present therein in the particle size distribution of the original dispersion.

Dispersible powders of this kind are used in many construction chemical products, for example in coating compositions or adhesives, such as tile adhesives, spackling compounds, self-leveling compounds, thermal insulation composite systems or jointing mortars. It is advantageous that dispersible powders can be used in preprepared, storable dry mixtures, optionally together with hydraulic binders, such as cement, said mixtures being converted into the ready-to-use product, through the addition of water and mixing, only immediately before use.

To improve their processing and performance properties, building material formulations are generally furnished with a number of additives, for example with polymer powders, thickeners, plasticizers, retarders, setting accelerators, defoamers, air-entraining agents, and many more. A disadvantage of building material formulations thus modified is that they can release low-molecular-weight, highly volatile substances and other hazardous substances, including ketones or alkanals, informally referred to as aldehydes, for example formaldehyde, acetaldehyde, propionaldehyde or higher homologs of the alkanal group of compounds. Such carbonyl compounds are generally reactive and many are classified as carcinogens, which is why emissions of aldehyde and ketone compounds must as far as possible be avoided as early as at the formulation stage. Otherwise, aldehydes or ketones may be released during the processing or use of the building material products and can endanger the health of users at the construction site or consumers, especially users in indoor spaces in private and commercial settings.

It is not generally possible at all for commercial compounders of building material formulations to establish which additive is responsible for the release of aldehydes or ketones. The methods for the qualitative and quantitative determination of low- to medium-volatility and low-molecular-weight chemicals is laborious and not routine method of analysis. As a further complicating factor, aldehyde or ketone impurities can be released from additives through chemical reactions only once the building material formulations have been produced, and consequently purification steps during production of the additives cannot solve the problem of aldehyde or ketone release completely. For example, aldehydes in a fresh mortar with high pH may be released through hydrolysis of residual monomeric vinyl esters of long-chain carboxylic acids, which, because of their low volatility, are not always completely removed by conventional methods such as stripping. However, dispersible powders per se do not generally constitute a significant aldehyde or ketone source, since any aldehyde or ketone component formed or introduced during production of the powder by emulsion polymerization, for example from initiators such as sodium formaldehyde sulfoxylate, are removed from the resulting dispersible powder composition at the latest during the drying of the polymer dispersions.

Against this background, the object was to provide measures with which the aldehyde or ketone concentration of building material formulations during or after application can be reduced.

Surprisingly, the object has been essentially achieved with water-redispersible dispersible powder compositions based on copolymers of a) vinyl acetate,
b) ethylene, c) optionally auxiliary monomers, and d) optionally further ethylenically unsaturated monomers, characterized in that
particular amino compounds are present and that
the auxiliary monomers c) and also the further ethylenically unsaturated monomers d) are each selected from particular groups.

U.S. Pat. No. 6,080,806 recommends dispersible powder compositions of styrene-butadiene copolymers and amino acids for the improvement of mechanical properties such as impact resistance, flexibility or adhesion strength. US201727544 concerns aqueous dispersions comprising lysine as crosslinker and also crosslinkable copolymers of 1,3-dicarbonyl monomers and further monomers. U.S. Pat. No. 6,063,865 A relates to water-redispersible, crosslinkable powder composition containing a) 30 to 95 parts by weight of water-insoluble film-forming polymers of ethylenically unsaturated monomers, wherein 0.5% to 10% by weight of the monomers bear an aldehyde, keto, epoxy, isocyanate, carboxylic anhydride or aziridine group, b) 5 to 70 parts by weight of water-soluble film-forming polymers, and c) compounds having at least two functional groups present in salt form from the series of amines, hydrazides, hydroxylamine esters, and aryl or alkyl hydrazines or hydrazones. US20220135784 and US20100197831 relate to crosslinkable water-redispersible polymer powder compositions that comprise vinyl ester polymers and also epoxy compounds and optionally crosslinking curing agents having two or more amino groups.

The invention provides water-redispersible dispersible powder compositions (dispersible powder compositions) based on copolymers of a) vinyl acetate,
b) ethylene, c) optionally one or more auxiliary monomers, and d) optionally one or more further ethylenically unsaturated monomers, characterized in that one or more amino compounds (nitrogen compounds) selected from the group comprising polyoxyalkylene amines, polyethyleneimines, aliphatic polyamines, and compounds of formula R—NR′H are present,
where, in formula R—NR′H, the radical R is a linear or branched, optionally substituted hydrocarbon radical having 1 to 20 carbon atoms and R′ is a hydrogen atom, an NH₂ group or a carbonyl radical,
with the proviso that the auxiliary monomers c) are selected from the group comprising ethylenically unsaturated mono- and dicarboxylic acids; ethylenically unsaturated carboxylic acid nitriles; acrylamide (CH₂CHCONH₂); ethylenically unsaturated sulfonic acids; ethylenically unsaturated silicon-functional monomers; and hydroxyethyl, hydroxypropyl or hydroxybutyl acrylate or methacrylate and that the further ethylenically unsaturated monomers d) are selected from the group comprising methyl acrylate, methyl methacrylate, ethyl acrylate, ethyl methacrylate, propyl acrylate, propyl methacrylate, n-butyl acrylate, n-butyl methacrylate, 2-ethylhexyl acrylate, norbornyl acrylate, vinyl aromatics, and vinyl halides and that the water-redispersible dispersible powder compositions do not contain any compounds bearing epoxy groups (epoxy compounds).

The nitrogen compounds preferably contain one or more amino groups, more preferably 1 to 50 amino groups, even more preferably 1 to 10 amino groups, particularly preferably 1 to 5 amino groups, most preferably 1 to 3 amino groups, and most preferably of all two amino groups.

The radical R in the compounds of formula R—NR′H is preferably a linear or branched, optionally substituted hydrocarbon radical having 1 to 15 carbon atoms, preferably 1 to 10 carbon atoms, and more preferably 1 to 5 carbon atoms.

Preferred substituents in the radicals R are acid, amide, amine, alcohol, oxyalkylene, thiol or thioether groups, such as methyl thioether radicals, or aromatic or heteroaromatic radicals, such as phenyl or imidazole radicals. Preferred substituents in the R radicals are amine or acid groups, such as sulfonic acid or preferably carboxylic acid groups. Preferably, the radicals R bear at least two substituents, especially two substituents.

The radical R′ is preferably a carbonyl radical and more preferably a hydrogen atom. Nitrogen compounds having a carbonyl radical as radical R′ are also referred to as amides. Carbonyl radicals contain preferably 1 to 20 carbon atoms, more preferably 1 to 10 carbon atoms, and most preferably 1 to 5 carbon atoms.

Preferred compounds of the formula R—NR′H are aliphatic or aromatic amines and especially amino acids.

Examples of aliphatic or aromatic amines are hexamethylenediamine, diethylenetriamine, tetraethylenepentamine, tetraethylenepentamine, 1,2-diaminopropane, diproprenediamine, diethylaminopropylamine, phenylenediamine, and isophoronediamine.

Preference is given to natural amino acids, especially proteinogenic amino acids. Most preferred amino acids are glycine, aspartic acid, glutamic acid, and especially lysine.

The nitrogen compounds of formula R—NR′H have a molecular weight MW of preferably ≤500 g/mol, more preferably ≤300 g/mol and most preferably ≤200 g/mol. The nitrogen compounds of the formula R—NR′H have a molecular weight MW of preferably ≥50 g/mol and more preferably ≥75 g/mol.

Polyoxyalkylene amines are preferably polyoxyalkylenes bearing one or more amino groups, preferably one to three amino groups, and more preferably two amino groups. The polyoxyalkylene unit is here preferably based on ethylene oxide (EO) groups, propylene oxide (PO) groups and/or butylene oxide groups. Ethylene oxide (EO) groups and/or propylene oxide (PO) groups are more preferred. Polyalkoxylene glycols preferably bear an amine group at one end or, more preferably, at both ends of the chain. Polyoxyalkylene amines are available for example under the Jeffamine® trade name.

Polyethyleneimines are preferably polymers having the repeating structural unit-CH₂—CH₂—NH—. Such polyethyleneimines are commercially available for example under the Lupasol® trade name from BASF SE.

Aliphatic polyamines are also generally known and are commercially available for example under the Anquamine®, Epilink® and Epilox® curing agent trade names.

The polyoxyalkylene amines, polyethyleneimines, and aliphatic polyamines have a molecular weight MW of preferably ≤1 000 000 g/mol, more preferably ≤500 000 g/mol, even more preferably ≤100 000 g/mol, particularly preferably ≤50 000 g/mol, and most preferably ≤10 000 g/mol. The polyoxyalkylene amines, polyethyleneimines, and aliphatic polyamines have a molecular weight MW of preferably ≥200 g/mol, more preferably ≥300 g/mol, and most preferably ≥400 g/mol.

20 The nitrogen compounds may also be present in the form of salts, for example in the form of their ammonium salts, for example with acid groups, such as carboxylic acids, or halides as counterion.

Preferred nitrogen compounds are polyoxyalkylene amines and compounds of the formula R—NR′H, especially amino acids.

The dispersible powder compositions contain preferably 0.1% to 30% by weight, more preferably 0.2% to 20% by weight, even more preferably 0.3% to 15% by weight, particularly preferably 0.3% to 12% by weight, most preferably 0.3% to 10% by weight, and most preferably of all 0.3% to 3% by weight, of nitrogen compounds, based on the total weight of the dispersible powder compositions.

The copolymers are based on a) vinyl acetate, b) ethylene, c) optionally one or more auxiliary monomers, and d) optionally one or more further ethylenically unsaturated monomers.

The dispersible powder compositions contain preferably 40% to 99% by weight, more preferably 50% to 95% by weight, and most preferably 70% to 90% by weight, of copolymers of the invention, based on the total weight of the dispersible powder compositions.

The copolymers are based on vinyl acetate a) to an extent of preferably 50% to <100% by weight, more preferably 59.8% to 94% by weight, and most preferably 68.5% to 90% by weight, based on the total weight of the copolymers.

The copolymers are based on ethylene b) to an extent of preferably >0% to 50% by weight, more preferably 0.1% to 40% by weight, and most preferably 1% to 30% by weight, based on the total weight of the copolymers.

The auxiliary monomers c) are selected from the group comprising ethylenically unsaturated mono- and dicarboxylic acids, preferably acrylic acid, methacrylic acid, fumaric acid, and maleic acid; ethylenically unsaturated carboxylic acid nitriles, preferably acrylonitrile; acrylamide (CH₂CHCONH₂); ethylenically unsaturated sulfonic acids or salts thereof, preferably vinylsulfonic acid, 2-acrylamido-2-methylpropanesulfonic acid; ethylenically unsaturated silicon-functional monomers, such as acryloyloxypropyltri(alkoxy)silanes and methacryloyloxypropyltri(alkoxy)silanes, vinyltrialkoxysilanes, and vinylmethyldialkoxysilanes, wherein methoxy, ethoxy, and ethoxypropylene glycol ether radicals may for example be present as alkoxy groups; and hydroxyethyl, hydroxypropyl or hydroxybutyl acrylate or methacrylate.

Particularly preferred auxiliary monomers c) are ethylenically unsaturated acids, such as acrylic acid, methacrylic acid, and vinylsulfonic acid.

The auxiliary monomers c) are generally different from vinyl acetate a), ethylene b), and the optional further ethylenically unsaturated monomers d).

The copolymers are based on auxiliary monomers c) to an extent of preferably 0% to 20% by weight, more preferably 0.1% to 10% by weight, and most preferably 0.5% to 5% by weight, based on the total weight of the copolymers.

The further ethylenically unsaturated monomers d) are selected from the group comprising methyl acrylate, methyl methacrylate, ethyl acrylate, ethyl methacrylate, propyl acrylate, propyl methacrylate, n-butyl acrylate, n-butyl methacrylate, 2-ethylhexyl acrylate, norbornyl acrylate, vinyl aromatics, especially styrene and vinyltoluene, and vinyl halides, such as vinyl chloride. Particular preference is given to vinyl chloride, methyl methacrylate, n-butyl acrylate, and styrene. Most preferred is vinyl chloride.

The further ethylenically unsaturated monomers d) are generally different from vinyl acetate a), ethylene b), and the optional auxiliary monomers c).

The copolymers are based on further ethylenically unsaturated monomers d) to an extent of preferably 0% to <50% by weight, more preferably 0.1% to 40% by weight, and most preferably 1% to 30% by weight, based on the total weight of the copolymers.

The copolymers preferably consist of units of vinyl acetate a), ethylene b), optionally auxiliary monomers c), and optionally further ethylenically unsaturated monomers d). More preferably, the copolymers consist of units of vinyl acetate a), ethylene b), and optionally further ethylenically unsaturated monomers d).

The monomers and the proportions by weight of the comonomers are selected so as to generally result in a glass transition temperature Tg of −50° C. to +40° C., preferably −30° C. to +35° C. The glass transition temperature Tg of the polymers can be determined in a known manner by differential scanning calorimetry (DSC). The Tg can also be predicted approximately by the Fox equation. According to Fox T. G., Bull. Am. Physics Soc. 1, 3, page 123 (1956): 1/Tg=x1/Tg1+x2/Tg2+ . . . +xn/Tgn, where xn is the mass fraction (% by weight/100) of the monomer n, and Tgn the glass transition temperature in kelvin of the homopolymer of the monomer n. Tg values for homopolymers are listed in Polymer Handbook 2nd Edition, J. Wiley & Sons, New York (1975).

The copolymers are preferably produced by the emulsion polymerization process. The emulsion polymerization is normally effected in an aqueous medium. The polymerization temperature is generally 40° C. to 110° C., preferably 60° C. to 95° C. The copolymerization of gaseous comonomers such as ethylene, 1,3-butadiene or vinyl chloride may also be operated under pressure, generally between 5 bar and 100 bar.

The polymerization can generally be initiated using the redox initiator combinations commonly used for emulsion polymerization. The monomer conversion may be controlled in the usual manner through the metering of the initiator. The initiators are generally metered in overall such that continuous polymerization is ensured.

Examples of suitable oxidation initiators include the sodium, potassium, and ammonium salts of peroxodisulfuric acid, hydrogen peroxide, t-butyl peroxide, t-butyl hydroperoxide, potassium peroxodiphosphate, tert-butyl peroxopivalate, cumene hydroperoxide, and azobisisobutyronitrile. Preference is given to the sodium, potassium and ammonium salts of peroxodisulfuric acid and to hydrogen peroxide. The initiators mentioned are generally used in an amount of 0.01% to 2.0% by weight based on the total weight of the monomers.

Examples of suitable reducing agents are the sulfites and bisulfites of the alkali metals and ammonium, such as sodium sulfite, derivatives of sulfoxylic acid, such as zinc or alkali metal formaldehyde sulfoxylates, for example sodium hydroxymethanesulfinate (Bruggolite), and (iso) ascorbic acid. Preference is given to sodium hydroxymethanesulfinate and (iso) ascorbic acid. The amount of reducing agent is preferably 0.015% to 3% by weight based on the total weight of the monomers.

The oxidizing agents mentioned, in particular the salts of peroxodisulfuric acid and also hydrogen peroxide, may also be used as thermal initiators on their own.

Substances that act as chain-transfer agents may be used during the emulsion polymerization process to control the molecular weight. When chain-transfer agents are used, they are usually used in amounts of between 0.001% to 5.0% by weight, based on the monomers to be polymerized, and are metered in separately or else in the form of a premix with reaction components. Examples of such substances are n-dodecyl mercaptan, tert-dodecyl mercaptan, mercaptopropionic acids or alkali metal salts thereof, methyl mercaptopropionate, isopropanol, phosphonic acid or derivatives thereof, phosphinic acid or derivatives thereof, and acetaldehyde. Preference is given to using 2-mercaptopropionic acid or tert-dodecyl mercaptan.

For stabilization it is possible to use protective colloids, optionally in combination with emulsifiers. In the emulsion polymerization process, polymerization can also be carried out in the presence of emulsifiers. Preferred amounts of emulsifiers are 1% to 7% by weight based on the total weight of the monomers. Examples of emulsifiers are anionic, cationic or nonionic emulsifiers, such as anionic surfactants, especially alkyl sulfates having a chain length of 8 to 18 carbon atoms, alkyl or alkylaryl ether sulfates having 8 to 18 carbon atoms in the hydrophobic radical and up to 40 ethylene oxide or propylene oxide units, alkyl or alkylaryl sulfonates having 8 to 18 carbon atoms, esters and monoesters of sulfosuccinic acid with monohydric alcohols or alkylphenols, or nonionic surfactants such as alkyl polyglycol ethers or alkylaryl polyglycol ethers having 8 to 40 ethylene oxide units.

The polymerization is particularly preferably carried out in the absence of emulsifiers. The aqueous dispersions and/or the polymer powders preferably do not contain any emulsifiers.

On conclusion of the polymerization, residual monomers can be removed by postpolymerization employing known methods, for example by redox catalyst-initiated postpolymerization. Volatile residual monomers can also be removed by distillation, preferably under reduced pressure, and optionally while passing inert entraining gases, such as air, nitrogen or water vapor, through or over.

The copolymers obtainable in this way are preferably present in the form of protective-colloid-stabilized aqueous dispersions. The copolymers of the invention are preferably stabilized protective colloids.

Examples of protective colloids are polyvinyl alcohols; polyvinyl acetals; polyvinylpyrrolidones; polysaccharides in water-soluble form, such as starches (amylose and amylopectin), celluloses and the carboxymethyl, methyl, hydroxyethyl, and hydroxypropyl derivatives thereof, dextrins and cyclodextrins; proteins such as casein or caseinate, soy protein, gelatin; lignosulfonates; synthetic polymers such as poly(meth)acrylic acid, copolymers of (meth)acrylates with carboxy-functional comonomer units, poly(meth)acrylamide, polyvinylsulfonic acids and the water-soluble copolymers thereof; melamine-formaldehyde sulfonates, naphthalene-formaldehyde sulfonates, styrene-maleic acid copolymers, and vinyl ether-maleic acid copolymers.

Preference is given to partially or fully hydrolyzed polyvinyl alcohols having a degree of hydrolysis of preferably 80 to 100 mol %. Particular preference is given to partially hydrolyzed polyvinyl alcohols having a degree of hydrolysis of 80 to 95 mol %, especially having a Höppler viscosity in a 4% aqueous solution of 1 to 30 mPa·s (Höppler method at 20° C., DIN 53015). Most preferred are polyvinyl alcohols having a degree of hydrolysis of 85 to 94 mol %, especially having a Höppler viscosity in a 4% aqueous solution of 3 to 15 mPa·s (Höppler method at 20° C., DIN 53015). The protective colloids mentioned are obtainable by processes known to those skilled in the art. Protective colloids are present in an amount of preferably 1% to 30% by weight, more preferably 3% to 20% by weight, based on the total weight of the copolymers.

The aqueous dispersions have a solids content of preferably 30% to 75% by weight, more preferably 45% to 70% by weight.

The aqueous dispersions of the copolymers can, in a conventional manner per se, be converted into copolymers in the form of water-redispersible powders, in a manner for example analogous to that described further below for the drying to produce the dispersible powder compositions.

The water-redispersible dispersible powder compositions do not contain any compounds bearing epoxy groups (epoxy compounds). Epoxy compounds are deleterious in achieving the object of the invention.

Examples of epoxy compounds are epoxy resins. These are, for example, bisphenol-A-type epoxy compounds, i.e. condensation products of bisphenol A and epichlorohydrin or methylepichlorohydrin. Other examples are bisphenol-F-based epoxy resins, which generally comprise a mixture of bisglycidyloxyphenylmethanes. Further examples include aliphatic epoxy compounds such as glycidyl ethers of aliphatic polyols, especially butyldiglycidyl ether; cycloaliphatic epoxy resins such as vinylcyclohexane dioxide, dicyclopentadiene dioxide, and 3,4-epoxy-6-methylcyclohexylmethyl; and heterocyclic epoxy compounds such as triglycidyl isocyanurate. Epoxy resins of this kind are commercially available, for example the bisphenol A and bisphenol F types in the form of Epilox® resins. Particularly preferably, there are no epoxy resins of the bisphenol A type and bisphenol F type present.

Other examples of epoxy compounds are bisglycidyloxyphenylmethane, butyldiglycidyl ether, vinylcyclohexane dioxide, dicyclopentadiene dioxide, 3,4-epoxy-6-methylcyclohexylmethyl, and triglycidyl isocyanurate.

Epoxy compounds also include free-radical-polymerizable epoxy compounds having at least two epoxy groups per molecule. The epoxy compounds may be aliphatic, aliphatic or aromatic in nature.

The invention further provides processes for producing the water-redispersible dispersible powder compositions (dispersible powder compositions), characterized in that
copolymers based on a) vinyl acetate, b) ethylene, c) optionally one or more auxiliary monomers, and d) optionally one or more further ethylenically unsaturated monomers and
one or more amino compounds (nitrogen compounds) selected from the group comprising polyoxyalkylene amines, polyethyleneimines, aliphatic polyamines, and compounds of formula R—NR′H are mixed,
where, in formula R—NR′H, the radical R is a linear or branched, optionally substituted hydrocarbon radical having 1 to 20 carbon atoms and R′ is a hydrogen atom, an NH₂ group or a carbonyl radical,
with the proviso that the auxiliary monomers c) are selected from the group comprising ethylenically unsaturated mono- and dicarboxylic acids; ethylenically unsaturated carboxylic acid nitriles; acrylamide (CH₂CHCONH₂); ethylenically unsaturated sulfonic acids; ethylenically unsaturated silicon-functional monomers; and hydroxyethyl, hydroxypropyl or hydroxybutyl acrylate or methacrylate and that the further ethylenically unsaturated monomers d) are selected from the group comprising methyl acrylate, methyl methacrylate, ethyl acrylate, ethyl methacrylate, propyl acrylate, propyl methacrylate, n-butyl acrylate, n-butyl methacrylate, 2-ethylhexyl acrylate, norbornyl acrylate, vinyl aromatics, and vinyl halides and that no compounds bearing epoxy groups (epoxy compounds) are introduced into the water-redispersible dispersible powder compositions.

The mixing of the nitrogen compounds generally takes place after the production of the copolymers by polymerization.

The mixing of the copolymers with the nitrogen compounds can take place for example before, during or after the drying of the aqueous dispersions of the copolymers (polymer dispersion). Preferably, the addition of the nitrogen compounds takes place before the drying of the aqueous polymer dispersion. For this, preferably one or more nitrogen compounds are added to the aqueous polymer dispersions and the mixtures thus obtained then dried. Alternatively, one or more copolymers in the form of water-redispersible powders may be mixed with one or more nitrogen compounds.

Drying aids are generally added to the aqueous dispersions. The drying aid is generally used in a total amount of 0.5% to 30% by weight, especially 5% to 20% by weight, based on the solids content of the aqueous dispersion. The total amount of drying aid and protective colloid before the drying process is preferably 1% to 30% by weight based on the solids content of the aqueous dispersion.

The aqueous dispersions may be dried for example by fluidized-bed drying, freeze drying or spray drying. The dispersions are preferably spray dried. Spray drying is carried out in standard spray-drying systems, with atomization by means of one-, two- or multiphase nozzles or with a rotating disk. The chosen outlet temperature is generally in the range of 45° C. to 120° C., preferably 60° C. to 90° C., depending on the system, Tg of the resin, and desired degree of drying.

The viscosity of the feed to be atomized is adjusted via the solids content such that a value of <500 mPa·s (Brookfield viscosity at 20 revolutions and 23° C.), preferably <250 mPa·s, is obtained. The solids content of the dispersion to be atomized is preferably from 30% to 75% by weight, more preferably from 45% to 70% by weight.

A content of up to 1.5% by weight of defoamer, based on the copolymer, has proven advantageous in many cases. Defoamer is preferably added during drying.

To increase the storage stability by improving the blocking stability, particularly in the case of copolymers having a low glass transition temperature, the polymer powder obtained may be provided with for example one or more antiblocking agents (anticaking agents). The antiblocking agents are preferably added to the spray-drying system during or after drying, especially during drying. Preferred polymer powders comprise antiblocking agents, especially 1% to 40% by weight based on the total weight of polymeric constituents. Examples of antiblocking agents are calcium carbonate or magnesium carbonate, talc, gypsum, silica, kaolins such as metakaolin, and silicates, preferably having particle sizes within a range from 10 nm to 10 μm.

To improve the performance properties, it is possible to add further additives, for example during the drying. Examples of further constituents of dispersible powder compositions that are present in preferred embodiments are pigments, fillers, foam stabilizers, hydrophobizing agents or cement plasticizers.

The dispersible powder compositions, especially the copolymers based on the monomers a), b), optionally c), and optionally d) of the invention, preferably do not contain any reactive group that are able to react with the nitrogen compounds of the invention, especially the amino groups thereof, for example at a pH of 3 to 10 and/or temperatures up to 150° C. or for example during spray drying. This too helps achieve the object of the invention more readily.

The copolymers of the invention based on the monomers a), b), optionally c), and optionally d) preferably do not contain any monomer unit that is substituted with an aldehyde, keto, epoxy, isocyanate, carboxylic anhydride or aziridine group, especially no monomer unit substituted with an epoxy group. Examples of monomers containing aldehyde and keto groups are acrolein, vinyl methyl ketone, allyl acetoacetate, vinyl acetoacetate, vinyl or allyl bisacetoacetate, and acetoacetylated hydroxyalkyl (meth)acrylates. Examples of monomers containing epoxy groups are glycidyl acrylate, glycidyl methacrylate, glycidyl vinyl ether, and glycidyl allyl ether. Examples of isocyanates are meta- and para-isopropenyl-α,α-dimethylbenzyl isocyanate (TMI) and 2-methyl-2-isocyanatopropyl methacrylate, wherein the isocyanate groups of said monomers may optionally also be blocked, for example with phenol, salicylic esters, ketoxime, caprolactam, dialkyl malonates, alkyl acetoacetates or 2,2-dimethyl-1,3-dioxane-4,6-dione. Examples of anhydride comonomers are allylsuccinic anhydride and maleic anhydride. Particularly preferably, the copolymers do not contain any unit of monomers from the group comprising glycidyl (meth)acrylate, meta- and para-isopropenyl-α,α-dimethylbenzyl isocyanate (TMI), allyl acetoacetate, acetoacetylated hydroxyethyl (meth)acrylate, and acetoacetylated hydroxypropyl(meth)acrylate. Most preferably, the copolymers do not contain any glycidyl(meth)acrylate unit.

The dispersible powder compositions are particularly suitable for use in construction chemical products. They can be used alone or in combination with conventional polymer dispersions or dispersible powders.

The invention further provides building material dry formulations based on one or more hydraulically setting binders, such as cement (portland cement, aluminate cement, trass cement, slag cement, magnesia cement, phosphate cement), gypsum and water glass;
one or more dispersible powder compositions of the invention;
optionally one or more fillers, for example quartz sand, quartz powder, limestone powder, calcium carbonate, calcium magnesium carbonate (dolomite), chalk or white hydrated lime; and
optionally one or more additions, such as crosslinkers, preservatives, film-forming aids, dispersants, foam stabilizers, plasticizers, flow improvers, flame retardants, dyes or biocides.

The building material dry formulations contain preferably 0.1% to 40% by weight, more preferably 0.3% to 25.0% by weight, and most preferably 0.5% to 15% by weight, of dispersible powder compositions according to the invention, in each case based on the total weight of the building material dry formulations.

The building material dry formulations contain for example >0% to 2.0% by weight, preferably >0% to 1.0% by weight, more preferably >0% to 0.5% by weight, even more preferably >0% to 0.3% by weight, and particularly preferably >0% to 0.2% by weight, of nitrogen compounds, based on the total weight of the building material dry formulations.

The building material dry formulations contain preferably 1% to 90% by weight, more preferably 5% to 45% by weight, and most preferably 10% to 35% by weight, of hydraulically setting binders, based on the total weight of the building material dry formulations.

The building material dry formulations contain preferably 10% to 99% by weight, more preferably 30% to 90% by weight, and most preferably 50% to 85% by weight, of fillers, based on the total weight of the building material dry formulations.

The building material formulations contain preferably 0.001% to 30% by weight, more preferably 0.01% to 8% by weight, and most preferably 0.03% to 4% by weight of additions, based on the dry weight of the building material formulations.

Aldehydes or ketones that may be present in the building material dry formulations preferably contain 1 to 20 carbon atoms, more preferably 1 to 10 carbon atoms, particularly preferably 1 to 5 carbon atoms, and most preferably 1 to 3 carbon atoms.

Examples of aldehydes are hexanal, propionaldehyde and especially formaldehyde and acetaldehyde. An example of a ketone is acetone.

The building material dry formulations containing aldehydes and ketones contain a total of preferably ≤1% by weight, more preferably ≤0.5% by weight, particularly preferably ≤0.1% by weight, most preferably ≤0.03% by weight, and most preferably of all ≤0.01% by weight of aldehydes and ketones, based on the total weight of the building material dry formulations.

The production of the building material dry formulations can take place in a conventional manner in conventional apparatuses. The amount of water required to process the building material dry formulations is normally added immediately before application, with mixing.

The building material dry formulations are suitable, for example, for the production of reinforcing compounds for thermal insulation composite systems, or for the production of adhesives or coating compositions. Examples of adhesives are adhesives for thermal insulation panels and soundproofing panels, tile adhesives, jointing mortars, and adhesives for bonding wood and wood-based materials. Examples of coating compositions are mortars, self-leveling and sealing compounds, screeds, and plasters.

Surprisingly, the dispersible powder compositions of the invention make it possible to reduce the concentration of aldehydes and ketones in building material formulations.

The examples that follow serve to further elucidate the invention.

### Copolymer Dispersion:

Aqueous dispersion of a polyvinyl alcohol-stabilized vinyl acetate-ethylene-vinyl chloride copolymer having a glass transition temperature of 13° C. The polyvinyl alcohol had a degree of hydrolysis of 88 mol % and a Höppler viscosity of 4 mPa·s (in 4% aqueous solution).

### Preparation of the Dispersible Powder Compositions (DPP) of (Comparative) Examples 1-4

The copolymer dispersion was optionally mixed with a nitrogen compound, as specified in Table 1, and dried by spray drying in a conventional manner per se at an inlet temperature of 130° C. and an outlet temperature of 80° C., thereby affording a dispersible powder composition. 5% by weight of kaolin and 10% by weight of calcium carbonate were added to the dispersible powder composition as anticaking agents.

TABLE 1
Composition of the dispersible powder compositions:

| | Nitrogen compound ^{a)} |
|---|---|
| Comparative example 1 | — |
| Example 2 | 1% by weight of L-lysine |
| Example 3 | 2% by weight of L-lysine |
| Example 4 | 2% by weight of Jeffamine D-400 |

^{a)} based on the polymer content of the dispersion (solid/solid).

Preparation of the building material formulations of (comparative) examples 5-8: Cement, filler, cellulose ether, calcium formate, and the respective dispersible powder composition as specified in Table 2 were mixed.

Water was added to a content of 28% by weight, based on the total weight of the solids. The resulting building material formulation was homogenized for a total of 10 min in a planetary mixer.

The building material formulations correspond to a class C2S1 tile adhesive having an 8% content of polymeric binder and have the following make-up:

TABLE 2
Composition of the building material formulations:

| | Comp. ex. 5 | Ex. 6 | Ex. 7 | Ex. 8 |
|---|---|---|---|---|
| | [wt %] | [wt %] | [wt %] | [wt %] |
| CEM I 52.5 R | 45.0 | 45.0 | 45.0 | 45.0 |
| Quartz sand | 45.5 | 45.5 | 45.5 | 45.5 |
| Cellulose ether | 0.5 | 0.5 | 0.5 | 0.5 |
| Calcium formate | 1.0 | 1.0 | 1.0 | 1.0 |
| DPP from comparative | 8.0 | | | |
| example 1 | | | | |
| DPP from example 2 | | 8.0 | | |
| DPP from example 3 | | | 8.0 | |
| DPP from example 4 | | | | 8.0 |

### Testing for Aldehyde Emissions:

Aldehyde emissions were measured in accordance with ISO 16000-3. For this, the mortar sample was freshly stirred in a laboratory mixer with 28% by weight of water and spread evenly on a glass plate over an area of 0.096 m² using a smoothing spatula. The target layer thickness was 3 mm. The respective sample was then immediately transferred to the VOC test chamber (manufacturer Vötsch, volume=240 L). The chamber was set to a temperature of 23±1° C. and a humidity of 50±5%, at an air exchange rate of 2 L/min. Over a total period of 3 days, aldehyde emissions were collected via a DNPH column and quantitatively determined by gas chromatography.

The results of testing are summarized in Table 3.

Mortars containing the inventive powders of examples 2 to 4 showed significantly reduced aldehyde emissions.

TABLE 3
Results of the aldehyde emissions testing
of the building material formulations:

| Building | Dispersible | Amount of | Amount of |
|---|---|---|---|
| material | powder | acetaldehyde | propionaldehyde |
| formulation | composition | [μg/m³] | [μg/m³] |
| Comp. ex. 5 | Comp. ex. 1 | 33.4 | 17.4 |
| Ex. 6 | Ex. 2 | 5.7 | 1.4 |
| Ex. 7 | Ex. 3 | 2.2 | 1.0 |
| Ex. 8 | Ex. 4 | 3.2 | 0.7 |

1-13. (canceled)

14. A water-redispersible dispersible powder composition based on copolymers of
a) vinyl acetate, b) ethylene, c) optionally one or more auxiliary monomers, and
d) optionally one or more further ethylenically unsaturated monomers, characterized in that
one or more amino compounds selected from the group comprising polyoxyalkylene amines, polyethyleneimines, aliphatic polyamines, and compounds of formula R—NR′H are present therein,
where, in formula R—NR′H, the radical R is a linear or branched, optionally substituted hydrocarbon radical having 1 to 20 carbon atoms and
R′ is a hydrogen atom, an NH₂ group or a carbonyl radical,
with the proviso that the substituents of the substituted hydrocarbon radicals of the radical R in the formula R—NR′H are selected from the group consisting of acid, amide, amine, and oxyalkylene groups, aromatic radicals, and heteroaromatic radicals,
the auxiliary monomers c) are selected from the group comprising ethylenically unsaturated mono- and dicarboxylic acids; ethylenically unsaturated carboxylic acid nitriles; acrylamide; ethylenically unsaturated sulfonic acids; ethylenically unsaturated silicon-functional monomers; and hydroxyethyl, hydroxypropyl or hydroxybutyl acrylate or methacrylate and that
the further ethylenically unsaturated monomers d) are selected from the group comprising methyl acrylate, methyl methacrylate, ethyl acrylate, ethyl methacrylate, propyl acrylate, propyl methacrylate, n-butyl acrylate, n-butyl methacrylate, 2-ethylhexyl acrylate, norbornyl acrylate, vinyl aromatics, and vinyl halides and that
the water-redispersible dispersible powder composition is based to an extent of 40% to 99% by weight of copolymers of a) vinyl acetate, b) ethylene, c) optionally auxiliary monomers, and d) optionally further ethylenically unsaturated monomers, based on the total weight of the water-redispersible dispersible powder composition, and that the water-redispersible dispersible powder composition does not contain any compounds bearing epoxy groups.

15. The water-redispersible dispersible powder composition as claimed in claim 14, wherein each amino compound contains 1 to 50 amino groups.

16. The water-redispersible dispersible powder composition as claimed in claim 14, wherein the radicals R bear one or more substituents selected from the group consisting of acid and amine groups.

17. The water-redispersible dispersible powder composition as claimed in claim 14, wherein one or more amino compounds are selected from the group comprising hexamethylenediamine, diethylenetriamine, tetraethylenepentamine, diproprenediamine, diethylaminopropylamine, phenylenediamine, isophoronediamine, glycine, aspartic acid, glutamic acid, and lysine.

18. The water-redispersible dispersible powder composition as claimed in claim 14, wherein the polyoxyalkylene amines are based on units of ethylene oxide (EO), propylene oxide (PO) and/or butylene oxide and bear one or more amino groups and that polyethyleneimines are based on —CH₂—CH₂—NH— structural units.

19. The water-redispersible dispersible powder composition as claimed in claim 14, wherein the water-redispersible dispersible powder composition contains 0.1% to 20% by weight of amino compounds, based on the total weight of the water-redispersible dispersible powder composition.

20. The water-redispersible dispersible powder composition as claimed in claim 14, wherein the water-redispersible dispersible powder composition contains 50% to 95% by weight of copolymers of a) vinyl acetate, b) ethylene, c) optionally auxiliary monomers, and d) optionally further ethylenically unsaturated monomers, based on the total weight of the water-redispersible dispersible powder composition.

21. The water-redispersible dispersible powder composition as claimed in claim 14, wherein the water-redispersible dispersible powder composition does not contain any compounds bearing epoxy groups selected from the group comprising epoxy resins, aliphatic epoxy compounds, heterocyclic epoxy compounds, bisglycidyloxyphenylmethane, butanediol diglycidyl ether, vinylcyclohexane dioxide, dicyclopentadiene dioxide, 3,4-epoxy-6-methyl-cyclohexylmethyl, triglycidyl isocyanurate, and free-radical-polymerizable epoxy compounds having at least two epoxy groups per molecule.

22. A process for producing the water-redispersible dispersible powder compositions from claim 14, wherein the copolymers based on a) vinyl acetate, b) ethylene,
c) optionally auxiliary monomers, and d) optionally further ethylenically unsaturated monomers in the form of aqueous dispersions are dried and admixed with the amino compounds before, during or after drying; or that
the copolymers based on a) vinyl acetate, b) ethylene, c) optionally auxiliary monomers, and d) optionally further ethylenically unsaturated monomers in the form of water-redispersible powders are mixed with the amino compounds.

23. A building material dry formulation based on one or more hydraulically setting binders, one or more water-redispersible dispersible powder compositions as claimed in claim 14, optionally one or more fillers, and optionally one or more additions.

24. The building material dry formulation as claimed in claim 23, wherein >0% to 1.0% by weight of amino compounds are present therein, based on the total weight of the building material dry formulation.

25. The use of the building material dry formulation from claim 23 for the production of reinforcing compounds for thermal insulation composite systems, or for the production of adhesives or coating compositions.
